(19) United States
(12) Patent Application Publication
(10) Pub. No.: US 2006/0013113 A1
(43) Pub. Date: Jan. 19, 2006

(54) ROM type optical recording medium

(75) Inventors: Takashi Yamada, Tokyo (JP); Hisaji Oyake, Tokyo (JP); Kazuki Suzawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/180,577

(22) Filed: Jul. 14, 2005

(30) Foreign Application Priority Data
Jul. 15, 2004 (JP) 2004-208231

(51) Int. Cl. G11B 7/24

(52) U.S. Cl. 369/272.1; 369/275.1; 369/283

(57) ABSTRACT

An ROM type optical recording medium including a substrate 2, a reflecting layer 3 formed on one of the surfaces of the substrate 2, a first resin layer 4 formed on the reflecting layer 3, a first hard coat layer 5 formed on the first resin layer 4, a moisture-proof layer 6 formed on the other surface of the substrate 2, a second resin layer 7 formed on the moisture-proof layer 6, and a second hard coat layer 8 formed on the second resin layer 7, wherein the moisture-proof layer 6 contains, as a principal component, the same element as that contained as a principal component in the reflecting layer 3.

### BACKGROUND OF THE INVENTION

The present invention relates to an ROM type optical recording medium, and more particularly to an ROM type optical recording medium capable of controlling a warp as desired.

Conventionally, optical recording media represented by a CD and a DVD have been utilized widely as recording media for recording digital data. These optical recording media can be roughly divided into ROM type optical recording media which can neither once write nor rewrite data, for example, a CD-ROM and a DVD-ROM, write-once optical recording media which can once write data but cannot rewrite data, for example, a CD-R and a DVD-R, and rewritable optical recording media capable of rewriting data, for example, a CD-RW and a DVD-RW.

In the ROM type optical recording media, a concave pit or a convex pit is formed on the surface of a substrate and data are recorded through the pit and a space between the pits which are adjacent to each other. Digital data “0” or “1” are caused to correspond to the pit and the space respectively, and furthermore, a bit count of “0” or “1” is caused to correspond to their lengths. By modulating the lengths of the pit and the space, accordingly, it is possible to record desirable data.

In the case in which the recorded data are to be reproduced, a laser beam is irradiated along the pit formed on the surface of the substrate and the quantity of the reflected light of the laser beam is detected by a photodetector to read the shape of the surface of the substrate so that the data are reproduced.

In order to read the data recorded on the optical recording medium as desired, therefore, it is necessary to reliably cause a laser beam reflected by the optical recording medium to be incident on the light receiving surface of the photodetector.

In the case in which a great warp is generated on the optical recording medium by a change in a temperature or a humidity during use, however, the angle of incidence of the laser beam on the optical recording medium fluctuates. For this reason, there is a possibility that the reflected laser beam might not be reliably incident on the photodetector.

In order to reproduce the data recorded on the optical recording medium as desired, accordingly, the warp of the optical recording medium is to be reduced. JP-A-4-195745 Publication has disclosed an optical recording medium in which the warp is reduced by the formation of a layer for preventing the warp on the back side of the optical recording medium.

The optical recording medium described in the JP-A-4-195745 Publication comprises a first dielectric layer formed on the surface side of a substrate and a second dielectric layer formed on the back side of the substrate and having a coefficient of thermal expansion which is equal to that of the first dielectric layer. In such an optical recording medium, a stress and a bending moment which are generated on the first dielectric layer are cancelled with a stress and a bending moment which are generated on the second dielectric layer depending on a change in a temperature or a humidity during use. Thus, a warp is prevented from being generated on the optical recording medium.

On the other hand, in recent years, there has been proposed a next generation ROM type optical recording medium having a larger capacity and a higher data transfer rate. In such a next generation ROM type optical recording medium, a numerical aperture NA of an objective lens for collecting a laser beam is increased, and furthermore, a wavelength λ of the laser beam is reduced to enhance a recording density.

When the numerical aperture NA of the objective lens for collecting a laser beam is increased, however, there is a problem in that an angle error permitted for the tilt of the optical axis of the laser beam to the optical recording medium, that is, a tilt argin T is greatly reduced as shown in the following equation (1).

$$T ∝ \frac{λ}{d \cdot {NA}^{3}} \qquad ( 1 )$$

In the equation (1), d represents a thickness of a layer through which a laser beam is transmitted until the laser beam reaches the pit formed on the surface of the substrate. As is apparent from the equation (1), the tilt margin T is reduced when the NA of the objective lens is increased, and is increased when the thickness d of the layer through which the laser beam is transmitted is reduced.

Therefore, the next generation ROM type optical recording medium has such a structure that a thin resin layer having a thickness of approximately 100 μm is formed on the surface of a reflecting layer provided on a substrate and a laser beam is irradiated from the resin layer side to reproduce data. Consequently, the tilt margin is enlarged.

As described above, in the next generation ROM type optical recording medium, the thin resin layer having the thickness of approximately 100 μm is formed on the reflecting layer. Therefore, the reflecting layer and the resin layer are usually laminated and formed sequentially on a substrate having a thickness of approximately 1.1 mm. For this reason, the next generation ROM type optical recording medium has an asymmetrical structure differently from a DVD-ROM having a symmetrical structure in which two disk-shaped substrates having a thickness of 0.6 mm are stuck to each other with a reflecting layer interposed therebetween.

In the next generation ROM type optical recording medium, accordingly, a warp is easily generated on the optical recording medium due to a change in a temperature or a humidity. In the case in which the substrate and the resin layer are formed by different materials, particularly, physical properties such as a rigidity, a coefficient of linear expansion, a modulus of direct elasticity and an internal stress of the material forming the substrate and the material forming the resin layer are different from each other. For this reason, the warp is generated on the optical recording medium much more easily.

In the next generation ROM type optical recording medium, particularly, there is a problem in that the warp is generated easily. Also in the next generation ROM type optical recording medium, therefore, there has been made a trial of forming, on the back side of the substrate, the resin layer having almost the same physical properties as those of the resin layer provided on the surface side of the substrate and offsetting stresses applied to the surface and back face of the substrate each other, thereby reducing a warp to be generated on the optical recording medium.

Even if the resin layer is actually formed on both the surface and the back face of the substrate by using the same resin material, however, it is impossible to avoid a variation in the physical properties of each resin layer and it is hard to suppress the warp generated on the optical recording medium as desired.

### SUMMARY OF THE INVENTION

Accordingly, it is an object of the invention to provide an ROM type optical recording medium capable of suppressing a warp as desired.

In order to achieve the object, the inventor reached the following conclusion as a result of vigorous and repetitive studies. More specifically, even if the resin layer is formed on the surface and back sides of the substrate by using the same ultraviolet curing resin, a variation is made in the physical properties of the resin layer formed on the surface side of the substrate and the resin layer formed on the back side of the substrate. The reason might be that some sort of change is made on the ultraviolet curing resin by the influence of a layer provided under the resin layer in a process for curing the ultraviolet curing resin.

Therefore, the inventors further made various trials and errors repetitively. As a result, they found that two resin layers having almost the same physical properties can be formed on both sides of the substrate in the case in which a moisture-proof layer containing, as a principal component, the same element as that contained as a principal component in a reflecting layer is formed on the back side of the substrate, and one of the resin layers is formed on the reflecting layer and the other resin layer is formed on the moisture-proof layer.

In this specification, the containment of an element as a principal component in a certain layer implies that the content of the element is the largest of the elements contained in the same layer.

The invention is based on the knowledge and the object of the invention is achieved by an ROM type optical recording medium comprising a substrate, a first resin layer and a second resin layer which are formed on both sides of the substrate, a reflecting layer formed between the first resin layer and the substrate, and a moisture-proof layer formed between the second resin layer and the substrate, wherein the moisture-proof layer contains, as a principal component, the same element as that contained as a principal component in the reflecting layer.

According to the invention, it is possible to prevent the physical properties of the first resin layer to be the resin layer on the surface side of the substrate and the second resin layer to be the resin layer on the back side of the substrate from being greatly different from each other. Consequently, it is possible to offset stresses applied to the surface and back face of the substrate. Accordingly, the generation of a warp on the optical recording medium due to a change in a temperature or a humidity can be suppressed as desired.

In a more preferred embodiment of the invention, the reflecting layer contains a metal as the principal component and the moisture-proof layer contains, as the principal component, the same metal as that contained as the principal component in the reflecting layer.

In a further preferred embodiment of the invention, the reflecting layer contains, as the principal component, Ag or an alloy containing Ag. In the case in which the reflecting layer contains Ag or the alloy containing Ag as the principal component, it is possible to form a reflecting layer having an excellent surface property. Accordingly, it is possible to reduce a noise contained in a reproducing signal.

In a further preferred embodiment of the invention, the substrate has a plurality of concave pits formed on a surface thereof, the concave pits having lengths which are greater than a basic length BL determined corresponding to data to be recorded and a length of a space between the concave pits which are adjacent to each other in a tracking direction being smaller than the basic length BL.

In the case in which the concave pit and the space which are formed on the surface of the substrate have such lengths, the lengths of the concave portion formed on the reflecting layer and the gap between the concave portions which are adjacent to each other in the tracking direction can be set to be almost equal to the basic length BL corresponding to the data to be recorded. Thus, it is possible to obtain a reproducing signal having an excellent jitter characteristic.

In a further preferred embodiment of the invention, the substrate has a plurality of convex pits formed on a surface thereof, the convex pits having lengths which are smaller than a basic length BL determined corresponding to data to be recorded and a length of a space between the convex pits which are adjacent to each other in a tracking direction being greater than the basic length BL.

In the case in which the convex pit and the space which are formed on the surface of the substrate have such lengths, the lengths of the convex portions formed on the reflecting layer and the gap between the convex portions which are adjacent to each other in the tracking direction can be set to be almost equal to the basic length BL corresponding to the data to be recorded. Thus, it is possible to obtain a reproducing signal having an excellent jitter characteristic.

According to the invention, it is possible to provide an ROM type optical recording medium capable of suppressing a warp as desired.

### BRIEF DESCRIPTION OF THE DRAWINGS

FIG. 1 is a schematic perspective view showing an optical recording medium according to a preferred embodiment of the invention,

FIG. 2 is a schematic enlarged sectional view showing a portion indicated as A in FIG. 1,

FIG. 3 is a schematic perspective view showing the surface of a substrate, and

FIG. 4 is a schematic enlarged sectional view showing a section taken along an X-X axis in FIG. 3, illustrating the sectional shapes of the surface of the substrate and the surface of a reflecting layer.

### DETAILED DESCRIPTION OF THE PREFERRED EMBODIEMENTS

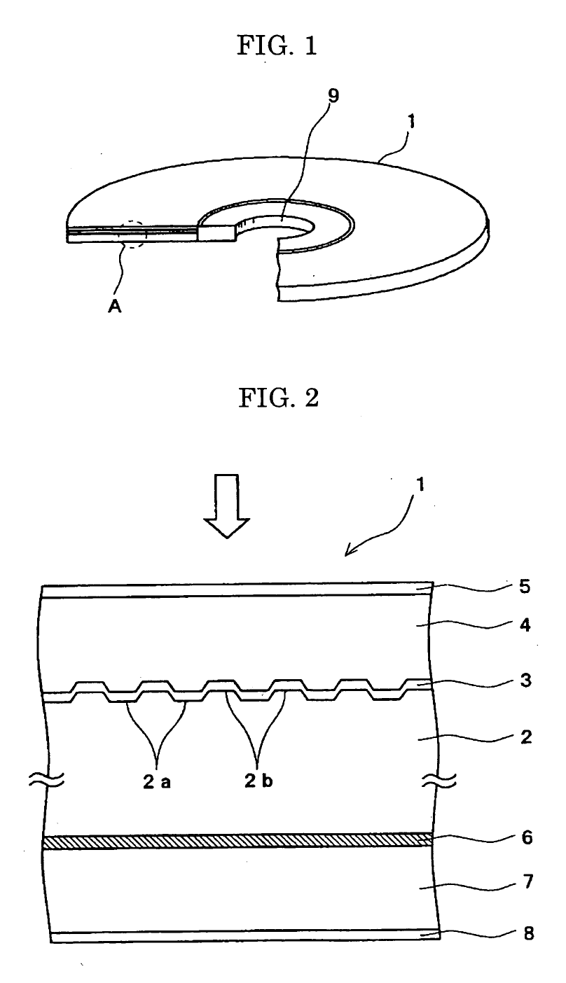

FIG. 1 is a schematic perspective view showing an ROM type optical recording medium according to a preferred embodiment of the invention, and FIG. 2 is a schematic enlarged sectional view showing a portion indicated as A in FIG. 1.

As shown in FIG. 1, an optical recording medium 1 takes the shape of a disk and has a central part on which a center hole 9 for setting the optical recording medium 1 onto a data reproducing device is formed.

The optical recording medium 1 shown in FIGS. 1 and 2 has such a structure that a laser beam having a wavelength λ of 380 nm to 450 nm is irradiated through an objective lens (not shown) having a numerical aperture NA to satisfy μ/NA≦640 nm in a direction shown in an arrow in FIG. 2 and data are thus reproduced.

As shown in FIG. 2, the optical recording medium 1 comprises a substrate 2, a reflecting layer 3 formed on one of the surfaces of the substrate 2, a first resin layer 4 formed on the reflecting layer 3, a first hard coat layer 5 formed on the first resin layer 4, a moisture-proof layer 6 formed on the other surface of the substrate 2, a second resin layer 7 formed on the moisture-proof layer 6, and a second hard coat layer 8 formed on the second resin layer 7.

The substrate 2 functions as the mechanical support of the optical recording medium 1.

A material for forming the substrate 2 which can function as the support of the optical recording medium 1 is not particularly restricted but a polycarbonate resin and an olefin resin can be used, for example. The thickness of the substrate 2 is not particularly restricted but is preferably approximately 1.1 mm.

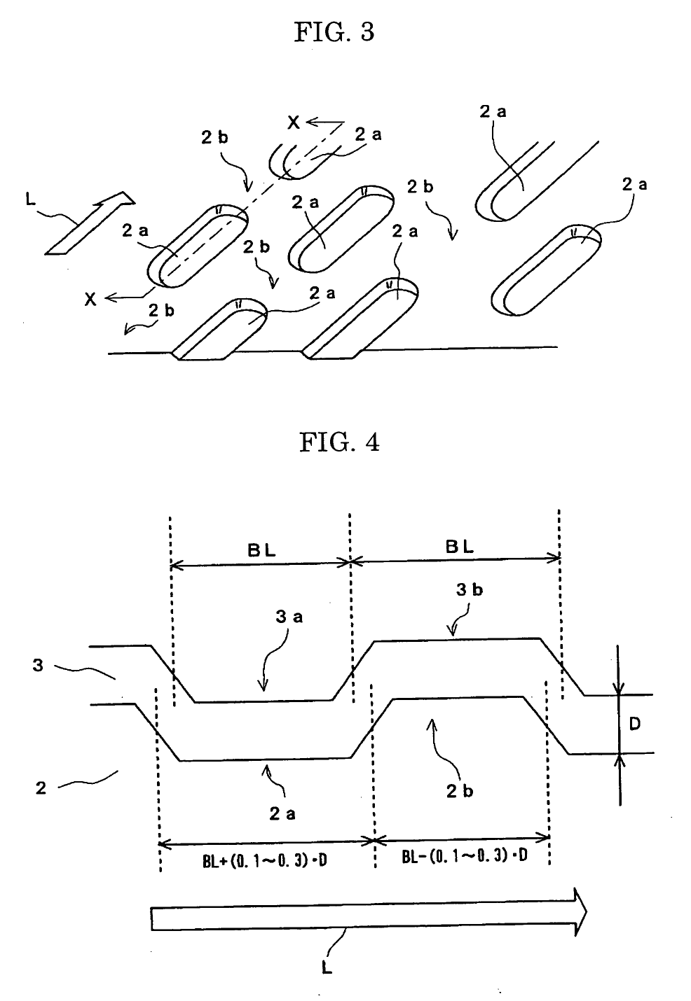

FIG. 3 is a schematic perspective view showing the surface of the substrate 2. In FIG. 3, an arrow L indicates the scan direction of a laser beam.

As shown in FIG. 3, a plurality of concave pits 2a taking an almost elliptical shape is formed on the surface of the substrate 2. The concave pits 2a are formed spirally from an inner peripheral side toward an outer peripheral side in the optical recording medium 1 or from the outer peripheral side toward the inner peripheral side, thereby constituting a track. Moreover, a region other than the concave pits 2a is formed flatly to constitute a space 2b. “0” or “1” of digital data is caused to correspond to the concave pit 2a and the space 2b between the concave pits 2a which are adjacent to each other in a tracking direction respectively, and the data are recorded by the concave pit 2a and the space 2b.

The depth of the concave pit 2a is determined corresponding to the wavelength of the laser beam to be irradiated. In the embodiment in which a laser beam having a wavelength of 380 nm to 450 nm is irradiated to reproduce data, the concave pit 2a is formed in a depth of 50 nm to 100 nm, for example.

FIG. 4 is a schematic enlarged sectional view taken along an X-X axis in FIG. 3, illustrating the sectional shapes of the surface of the substrate 2 and the surface of the reflecting layer 3 which will be described below. In FIG. 4, an arrow L indicates the scan direction of a laser beam.

In the optical recording medium 1 having such a structure that a laser beam is irradiated from the first resin layer 4 side, when the recorded data are to be reproduced, the laser beam incident on the optical recording medium 1 is reflected by the reflecting layer 3 before reaching the surface of the substrate 2. For this reason, a reproducing signal generated by a photodetector does not correspond to the shape of the surface of the substrate 2 but mainly corresponds to the shape of the surface of the reflecting layer 3.

A concave portion 3a formed on the reflecting layer 3 and a gap 3b between the concave portions 3a which are adjacent to each other in a tracking direction have different lengths from the lengths of the concave pit 2a and the space 2b which are formed on the surface of the substrate 2. For this reason, when the recorded data are reproduced, the length of a concavo-convex pattern detected by the photodetector is not coincident with a length corresponding to the recorded data. Consequently, there is a problem in that the jitter characteristic of the reproducing signal is deteriorated.

In the embodiment, therefore, the concave pit 2a to be formed on the surface of the substrate 2 is provided to be longer than a basic length BL by a length of (0.1 to 0.3)·D, while the space 2b between the concave pits 2a which are adjacent to each other in the tracking direction is formed to be shorter than the basic length BL by the length of (0.1 to 0.3)·D as shown in FIG. 4.

D represents a distance from the surface of the reflecting layer 3 to that of the substrate 2 and the thickness of the reflecting layer 3 in the embodiment. Moreover, the basic length BL is determined corresponding to a bit count of “0” or “1” of data to be recorded and has seven lengths of 149 nm, 223.5 nm, 298 nm, 372.5 nm, 447 nm, 521.5 nm and 596 nm corresponding to 2T to 8T in the case in which data of 2T to 8T modulated by a 1-7RLL modulation are to be recorded on the optical recording medium 1 in a recording capacity of 25 GB, for example.

In the case in which the concave pit 2a on the surface of the substrate 2 is formed to be longer than the basic length BL by the length of (0.1 to 0.3)·D, and furthermore, the space 2b on the surface of the substrate 2 is formed to be shorter than the basic length BL by the length of (0.1 to 0.3)·D, the lengths of the concave portion 3a formed on the reflecting layer 3 and the gap 3b between the concave portions 3a can be set to be almost equal to the basic length BL corresponding to the data to be recorded so that a reproducing signal having an excellent jitter characteristic can be obtained.

As shown in FIG. 2, the reflecting layer 3 is formed on the substrate 2.

The reflecting layer 3 has the function of reflecting a laser beam incident through the first hard coat layer 5 and the first resin layer 4 and emitting the laser beam again from the first hard coat layer 5 side.

A material for forming the reflecting layer 3 which can reflect a laser beam is not particularly restricted but can be formed to contain, as a principal component, a dielectric material constituted by at least one metal selected from the group consisting of Mg, Al, Ti, Cr, Fe, Co, Ni, Cu, Zn, Ge, Pt, Au, Ag, Pd, Nd, In, Sn and Bi or their alloys, or oxides, nitrides, sulfides or fluorides containing at least one metal selected from the group consisting of Si, Al, Ta, Ti, Co, Zr, Pb, Ag, Zn, Sn, Ca, Ce, V, Cu, Fe and Mg or their composites.

The thickness of the reflecting layer 3 is not particularly restricted but is preferably 20 nm to 100 nm and is more preferably 20 nm to 50 nm. If the thickness of the reflecting layer 3 is smaller than 20 nm, it is hard to satisfy a reflectance required for the reflecting layer 3. On the other hand, if the thickness of the reflecting layer 3 is greater than 100 nm, a long time is required for forming the reflecting layer 3. Therefore, there is a possibility that a productivity might be deteriorated and a crack might be generated on the reflecting layer 3 by an internal stress.

The first resin layer 4 causes a laser beam to be transmitted therethrough, and at the same time, functions as a protecting layer for protecting the surface of the reflecting layer 3.

The first resin layer 4 is optically transparent and is required to have a small optical absorption and reflection and a small double refraction in the wavelength region of a laser beam to be used, that is, a range of 380 nm to 450 nm, and is formed by an ultraviolet curing resin, for example.

The ultraviolet curing resin to be used for forming the first resin layer 4 contains a photopolymerizing monomer, a photopolymerizing oligomer, a photoinitiator and other additives as desired. A monomer having a molecular weight of less than 2000 is suitable for the photopolymerizing monomer and examples of the photopolymerizing monomer include monofunctional (meth)acrylate and multifunctional (meth)acrylate. Moreover, examples of the photopolymerizing oligomer include an oligomer containing or introducing, in a molecule, a group to be crosslinked or polymerized by an ultraviolet irradiation such as an acrylic double bond, an allylic double bond or an unsaturated double bond. Furthermore, any well-known photoinitiator may be used, and a molecule cleavage type photopolymerizing initiator can be used for the photoinitiator, for example.

It is preferable that the first resin layer 4 should have a thickness of 30 μm to 200 μm.

The first hard coat layer 5 functions to physically protect the first resin layer 4 and to prevent the first resin layer 4 from being damaged.

A material for forming the first hard coat layer 5 is not particularly restricted but a material which is excellent in a transparency and an abrasion resistance is referable. It is preferable that the first hard coat layer 5 should be formed by a hard coating agent composition in which an inorganic particle having an average particle diameter of 100 nm or less is added to an ultraviolet curing resin.

The thickness of the first hard coat layer 5 is preferably 1 μm to 10 μm and is more preferably 1 μm to 5 μm. In the case in which the thickness of the first hard coat layer 5 is less than 1 μm, there is a possibility that a hardness or an abrasion resistance which is required for the first hard coat layer 5 cannot be satisfied. On the other hand, in the case in which the same thickness is greater than 10 μm, there is a possibility that a crack might be generated on the first hard coat layer 5 by an internal stress.

As shown in FIG. 2, the moisture-proof layer 6, the second resin layer 7 and the second hard coat layer 8 are formed on the other surface of the substrate 2.

The moisture-proof layer 6 functions to prevent water from entering the substrate 2 through the second resin layer 7.

In the embodiment, the moisture-proof layer 6 contains, as principal components, the same metal and dielectric material as those contained as principal components in the reflecting layer 3 and contains, as a principal component, the same element as that contained as the principal component in the reflecting layer 3.

According to the studies of the inventor, it has been found that two resin layers having almost the same physical properties can be formed on both sides of the substrate 2 in the case in which the moisture-proof layer 6 containing, as a principal component, the same element as that contained as a principal component in the reflecting layer 3 is formed on the back side of the substrate 2, and the first resin layer 4 is formed on the reflecting layer 3, and furthermore, the second resin layer 7 which will be described below is formed on the moisture-proof layer 6.

The reason why the first resin layer 4 and the second resin layer 7 which have almost the same physical properties can be formed on both sides of the substrate 2 when the moisture-proof layer 6 has such a structure is not always apparent. However, the following can be guessed. More specifically, the moisture-proof layer 6 contains, as the principal component, the same element as that contained as the principal component in the reflecting layer 3 so that the moisture-proof layer 6 and the reflecting layer 3 have almost the same reflecting characteristics and light absorbing characteristics for ultraviolet rays. As a result, the ultraviolet curing resin for forming the first resin layer 4 and the ultraviolet curing resin for forming the second resin layer 7 can be cured on almost the same curing conditions.

In the embodiment, it is preferable that the moisture-proof layer 6 should have the same reflecting characteristic and light absorbing characteristic for the ultraviolet rays. For this reason, it is preferable that the content of the element contained as the principal component in the moisture-proof layer 6 should be equal to that of the element contained as the principal component in the reflecting layer 3 and the moisture-proof layer 6 should have the same composition as that of the reflecting layer 3. Since the moisture-proof layer 6 also functions to prevent the water from entering the substrate 2, however, it does not need to have the same composition as that of the reflecting layer 3 within a range in which the physical properties of the first resin layer 4 and the second resin layer 7 can be set to be almost identical to each other but another element may be added thereto in order to enhance a moisture-proof characteristic and a film forming characteristic or the moisture-proof layer 6 may be formed in such a manner that the element contained as the principal component in the moisture-proof layer 6 has a different content from that of the element contained as the principal component in the reflecting layer 3.

Since the thickness of the moisture-proof layer 6 influences the reflecting characteristic and the light absorbing characteristic for the ultraviolet rays of the moisture-proof layer 6, moreover, it is preferably equal to the thickness of the reflecting layer 3. Since the thickness of the moisture-proof layer 6 also influences the moisture-proof characteristic of the moisture-proof layer 6, however, it does not need to be equal to the thickness of the reflecting layer 3 but may be greater than the thickness of the reflecting layer 3 within a range in which the physical properties of the first resin layer 4 and the second resin layer 7 can be almost identical to each other.

The second resin layer 7 functions to suppress the generation of a warp on the optical recording medium 1 by canceling a stress and a bending moment generated on the first resin layer 4 with a stress and a bending moment generated on the second resin layer 7.

In the second resin layer 7, it is preferable that the physical properties such as a rigidity, a coefficient of linear expansion, a modulus of direct elasticity and an internal stress should be the same as those of the first resin layer 4. Accordingly, it is preferable that the second resin layer 7 should be formed by the same ultraviolet curing resin as the ultraviolet curing resin to be used for forming the first resin layer 4. However, it is preferable that the ultraviolet curing resin for forming the second resin layer 7 should have almost the same physical properties as those of the first resin layer 4 after curing and it is not always necessary to form the second resin layer 7 by the same ultraviolet curing resin as that of the first resin layer 4.

In this specification, the ultraviolet curing resin having almost the same physical properties as those of the first resin layer 4 after the curing has at least differences in the modulus of direct elasticity and the coefficient of linear expansion of 5% or less from those in the first resin layer 4.

It is preferable that the thickness of the second resin layer 7 should be 30 μm to 200 μm in the same manner as that of the first resin layer 4. However, the thickness of the second resin layer 7 does not need to be equal to that of the first resin layer 4 but may be different from that of the first resin layer 4 within a range in which the physical properties of the second resin layer 7 are not greatly different from those of the first resin layer 4.

The second hard coat layer 8 has the function of offsetting a stress generated in the first hard coat layer 5 by a stress generated therein.

It is preferable that the second hard coat layer 8 should have the same physical properties as those of the first hard coat layer 5 and should be formed by the same hard coating agent composition as that of the first hard coat layer 5.

The thickness of the second hard coat layer 8 is preferably 1 μm to 10 μm in the same manner as that of the first hard coat layer 5, and is more preferably 1 μm to 5 μm.

The optical recording medium 1 having the above structure is manufactured in the following manner.

First of all, the substrate 2 having the concave pits 2a is formed on one of surfaces through injection molding by using a stamper.

Subsequently, the reflecting layer 3 is formed by vapor phase growth such as sputtering over almost the whole surface of the substrate 2 on which the concave pits 2a are formed.

Next, the reflecting layer 3 is coated with the ultraviolet curing resin by spin coating so that a coated film is formed, and ultraviolet rays are irradiated on the coated film so that an ultraviolet setting resin is cured and the first resin layer 4 is thus formed.

Then, the first resin layer 4 is coated with the ultraviolet curing resin and the hard coating agent composition containing an inorganic particle by the spin coating so that a coated film is formed, and the ultraviolet rays are irradiated on the coated film so that the first hard coat layer 5 is formed.

Thereafter, the substrate 2 is set onto a sputtering device in such a manner that the surface of the substrate 2 on which the concave pit 2a is not formed is positioned on an upper part, and the moisture-proof layer 6 containing, as a principal component, the same element as that contained as the principal component in the reflecting layer 3 is formed on the surface of the substrate 2 by the vapor phase growth such as the sputtering.

Subsequently, the moisture-proof layer 6 is coated with an ultraviolet curing resin having the same physical properties as those of the first resin layer 4 after curing by the spin coating so that a coated film is formed, and the ultraviolet rays are irradiated on the coated film so that the ultraviolet curing resin is cured and the second resin layer 7 is thus formed.

Finally, the second resin layer 7 is coated with a hard coat composition having the same physical properties as those of the first hard coat layer 5 after the curing by the spin coating so that a coated film is formed, and the ultraviolet rays are irradiated on the coated film so that the hard coat composition is cured and the second hard coat layer 8 is thus formed.

Consequently, the optical recording medium 1 is fabricated.

According to the embodiment, the moisture-proof layer 6 contains, as the principal component, the same element as that contained as the principal component in the reflecting layer 3, and it is possible to prevent the physical properties of the first resin layer 4 to be the resin layer on the surface side of the substrate 2 from being greatly different from those of the second resin layer 6 to be the resin layer on the back side of the substrate 2. Consequently, it is possible to cancel stresses applied to the surface and back face of the substrate 2 each other. Accordingly, it is possible to suppress, as desired, the generation of a warp on the optical recording medium 1 due to a change in a temperature or a humidity.

### EXAMPLE

In order to make the advantages of the invention clearer, an example will be described below.

First of all, a polycarbonate substrate taking the shape of a disk having a thickness of 1.1 mm and an outside diameter of 120 mm was fabricated by injection molding.

Next, a reflecting layer containing Ag as a principal component and having a thickness of 50 nm was formed on one of the surfaces of the polycarbonate substrate by sputtering.

Subsequently, the polycarbonate substrate having the reflecting layer formed thereon was set onto a spin coating device and the reflecting layer was coated with an ultraviolet curing resin having the following composition by spin coating so that a coated film was formed. Then, ultraviolet rays were irradiated on the coated film in an integral light quantity of 3000 mJ/cm² to cure the ultraviolet curing resin so that a first resin layer having a thickness of 100 μm was formed.

| | | |
|---|---|---|
| Urethane acrylate (manufactured by Negami Chemical | 50 | mass % |
| Industrial Co., Ltd.: trade name “Art resin UN - 5200”) | | |
| Trimethylolpropane triacrylate (manufactured by | 33 | mass % |
| Nippon Kayaku Co., Ltd.: trade name “Kayarad TMPTA”) | | |
| Phenoxyhydroxypropyl acrylate (manufactured by | 14 | mass % |
| Nippon Kayaku Co., Ltd.: trade name “Kayarad R-128”) | | |
| 1-hydroxycyclohexylphenylketone (manufactured by | 3 | mass % |
| Ciba Geigy Ltd.: trade name “IRG184”) | | |

Then, the polycarbonate substrate having the first resin layer formed thereon was turned over and a moisture-proof layer containing Ag as a principal component and a thickness of 50 nm was formed on the other surface of the polycarbonate substrate by the sputtering.

Finally, the moisture-proof layer was coated with the same ultraviolet curing resin as that used in the formation of the first resin layer by the spin coating so that a coated film was formed. Thereafter, ultraviolet rays were irradiated on the coated film in an integral light quantity of 3000 mJ/cm² to cure the ultraviolet curing resin so that a second resin layer having a thickness of 100 μm was formed. Thus, a sample #1 was fabricated.

Furthermore, a sample #2 was fabricated in the same manner as the sample #1 except that a moisture-proof layer containing a mixture of ZnS and SiO₂ as a principal component was formed.

Next, the samples #1 and #2 were held until a water content in each sample was saturated in an atmosphere having a temperature of 25° C. and a relative humidity of 95% and the temperatures of the samples #1 and #2 were 25° C. respectively, and they were then set onto a high precision laser warp angle measuring device “LA-2000” (trade name) manufactured by Keyence Corporation to measure a warp angle β₁ in a position of 58 mm from the center of each of the samples #1 and #2.

Moreover, the samples #1 and #2 were set onto the high precision laser warp angle measuring device in an atmosphere having a temperature of 25° C. and a relative humidity of 10% respectively to measure a warp angle β₂ in the position of 58 mm from the center of each of the samples #1 and #2. The warp angle β₂ was continuously measured until the warp angle of each of the samples #1 and #2 was not changed in the atmosphere having the temperature of 25° C. and the relative humidity 10%, and a maximum value thereof was determined to be the warp angle β₂.

Both of the warp angles β₁ and β₂ were defined to be positive when the samples were warped toward the first resin layer side and to be negative when the samples were warped toward the second resin layer side.

Next, a difference (β₂−β₁) between the warp angle β₂ and the warp angle β₁ in each of the samples was obtained to evaluate the degree of the warp of each of the samples. In the evaluation of the degree of the warp, “GOOD” was given when the difference (β₂−β₁) between the warp angles was equal to or smaller than 0.35 deg and “BAD” was given when the difference (β₂−β₁) between the warp angles was greater than 0.35 deg. The result of the measurement is shown in Table 1.

TABLE 1

| | Warp angle | Warp angle | Difference in | |
|---|---|---|---|---|
| | β₁ (deg) | β₂ (deg) | warp angle (deg) | Evaluation |
| Sample #1 | 0.05 | −0.15 | 0.20 | GOOD |
| Sample #2 | 0.02 | −0.65 | 0.67 | BAD |

As shown in the Table 1, in the sample #1, the difference in the warp angle is 0.20 deg which is smaller than 0.35 deg. Consequently, it was found that the generation of the warp on the optical recording medium can be suppressed. On the other hand, in the sample #2, the difference in the warp angle is 0.67 deg. Thus, the difference in the warp angle could not be controlled to be equal to or smaller than 0.35 deg.

The invention is not restricted to the embodiments and examples described above but it is apparent that various changes can be made without departing from the scope of the invention described in claims and are also included in the scope of the invention.

For example, while the first hard coat layer 5 is formed on one of the sides of the substrate 2 and the second hard coat layer 8 is formed on the other side of the substrate 2 in the optical recording medium 1 shown in FIGS. 1 and 2, the two hard coat layers do not need to be provided and at least one of the first hard coat layer 5 and the second hard coat layer 8 can also be omitted.

While the concave pits 2a are formed on the surface of the substrate 2 in the embodiment, moreover, they do not need to be provided to form the pits and the space on the surface of the substrate 2 but a plurality of convex portions taking an almost elliptical shape may be provided to form convex pits and a space on the surface of the substrate 2. In the case in which the convex pits are formed on the surface of the substrate 2, thus, a concavo-convex relationship between the substrate 2 having the concave pits formed on the surface thereof and the pit and space is inverted. For this reason, the convex pit is formed to be shorter than the basic length BL by a length of (0.1 to 0.3)·D, while the space between the convex pits which are adjacent to each other in the tracking direction is formed to be longer than the basic length BL by the length of (0.1 to 0.3)·D.

What is claimed is:

1. An ROM type optical recording medium comprising:
a substrate;
a first resin layer and a second resin layer which are formed on both sides of the substrate;
a reflecting layer formed between the first resin layer and the substrate; and
a moisture-proof layer formed between the second resin layer and the substrate,
wherein the moisture-proof layer contains, as a principal component, the same element as that contained as a principal component in the reflecting layer.

2. The ROM type optical recording medium according to claim 1, wherein the reflecting layer contains a metal as the principal component and the moisture-proof layer contains, as the principal component, the same metal as that contained as the principal component in the reflecting layer.

3. The ROM type optical recording medium according to claim 1, wherein the reflecting layer contains, as the principal component, Ag or an alloy containing Ag.

4. The ROM type optical recording medium according to claim 1, wherein the substrate has a plurality of concave pits formed on a surface thereof, the concave pits having lengths which are greater than a basic length BL determined corresponding to data to be recorded and a length of a space between the concave pits which are adjacent to each other in a tracking direction being smaller than the basic length BL.

5. The ROM type optical recording medium according to claim 1, wherein the substrate has a plurality of convex pits formed on a surface thereof, the convex pits having lengths which are smaller than a basic length BL determined corresponding to data to be recorded and a length of a space between the convex pits which are adjacent to each other in a tracking direction being greater than the basic length BL.

6. An ROM type optical recording medium comprising:
a substrate;
a reflecting layer formed on one of surfaces of the substrate;
a first resin layer formed on the reflecting layer; and
a moisture-proof layer formed on the other surface of the substrate;
a second resin layer formed on the moisture-proof layer;
wherein the moisture-proof layer contains, as a principal component, the same element as that contained as a principal component in the reflecting layer.

7. The ROM type optical recording medium according to claim 6, further comprising:
a first hard coat layer formed on the first resin layer, and a second hard coat layer formed on the second resin layer.
